(19) United States
(12) Patent Application Publication
(10) Pub. No.: US 2011/0214598 A1
(43) Pub. Date: Sep. 8, 2011

(54) WINDOW DISPLAY HANGER FOR VEHICLE SALES MATERIAL

(76) Inventor: Anthony J. TUCKER, Albany, GA (US)

(21) Appl. No.: 13/040,759

(22) Filed: Mar. 4, 2011

Related U.S. Application Data
(60) Provisional application No. 61/310,435, filed on Mar. 4, 2010.
(60) Provisional application No. 61/408,328, filed on Oct. 29, 2010.

(51) Int. Cl. G09F 17/00; G09F 21/04; G09F 3/18; G09F 3/20

(52) U.S. Cl. 116/173; 40/643; 40/642.02

(57) ABSTRACT

An informational display device and method for displaying informational material about an item to potential customers for the item. The device includes a housing for removably receiving informational material, and a clip portion for attachment to the item. In example forms, a vehicle information sheet or buyer's guide is secured to a window of a vehicle and can be removed, replaced and reused. In one form, the display device is modular and includes a clip adapted to be slipped over the top of a door glass of the vehicle, a rail removably attached to the clip, and a document display housing secured to the rail and comprising an inner panel and an outer panel, and defining a chamber therebetween for receiving and displaying a document, with at least a portion of the document display housing being transparent to allow viewing of the document therethrough.

### CROSS-REFERENCE TO RELATED APPLICATIONS

This application claims priority to U.S. Provisional Patent Application Ser. No. 61/310,435, filed Mar. 4, 2010, and U.S. Provisional Patent Application Ser. No. 61/408,328, filed Oct. 29, 2010, the entireties of which applications are hereby incorporated herein by reference.

### TECHNICAL FIELD

The present invention relates generally to the field of display devices, and more particularly to a window hanger for displaying informational materials such as automotive sales data and buyers' guides.

### BACKGROUND OF THE INVENTION

Legal requirements and sound business practices commonly dictate that certain informational material be displayed to potential customers for sales of vehicles and other commercial activities. Typically, a “buyers guide” and or an informational “window sticker” providing information about a vehicle (including for example, year, make, model, warranty information, stock number, accessories, mileage, price, fuel economy, etc.) is adhesively applied onto the window of the vehicle on a sales lot. Use of such window stickers has become the standard practice in the trade, and those of ordinary skill in the art in this field typically accept the practice as a requirement of doing business and are unlikely to vary from the status quo.

### SUMMARY OF THE INVENTION

The present applicant for patent has identified certain shortcomings in the above-described conventional practices, and seeks to advance the state of the art in areas commonly considered not amenable to change by those of ordinary skill in the field. For example, removal of window stickers from an automobile window may leave an undesirable residue on the window, or even damage window tinting. Also, window sticker displays are difficult to update if pricing and other information needs to be changed. Moreover, conventional window stickers cannot be removed during test drives, which can obstruct the driver's vision causing safety concerns. While varying from the standard practice of window sticker displays may be considered unconventional by those in the field, the present invention provides an improved means of displaying informational materials such as automotive sales data and buyers' guides to potential customers for sales of vehicles and other commercial activities.

In one example aspect, the present invention comprises an information display device for displaying informational material regarding an item for sale to a potential customer, for example a vehicle information sheet such as a window sticker or buyers guide, a photograph of the vehicle, dealer information, or other information, displayed on an automobile. The information display device preferably includes a housing portion having an inner panel and an outer panel, and defining a chamber therebetween for receiving the informational material. At least a portion of the housing is transparent to allow viewing of the informational material therethrough. The information display device preferably also includes a clip portion at an upper end of the housing portion for attachment to the item for sale.

In another example aspect, the invention comprises a method of displaying information about an item. The method preferably includes the steps of providing an information display device having a housing portion and a clip portion; placing informational material about the item in the housing portion of the information display device; and removably securing the information display device to the item by means of the clip portion.

In another example aspect, the present invention comprises a modular information display device for displaying informational material about a vehicle for sale to a potential customer, for example a vehicle information sheet such as a window sticker or buyer's guide, a photograph of the vehicle, dealer information, or other information. The modular information display device preferably includes a clip to be slipped over a door glass of the vehicle and to which a variety of items can be attached. One item to be attached to the clip is a document display housing having an inner panel and an outer panel, and defining a chamber therebetween for receiving the informational material (sheet-like documents, typically). At least a portion of the housing is transparent to allow viewing of the informational material therethrough. The clip can be provided with an attachment point or retainer for supporting an accessory, such as a flag/flagpole to draw attention to the vehicle. Optionally, the housing is sized and adapted to contain and display standard letter-sized papers (such as 8.5×11 sheets). Moreover, optionally, the housing can be adapted to display such in a landscape orientation or in a portrait orientation. Furthermore, the clip can be adapted to be easily manipulated to allow rapid and easy attachment/removal of the document display housing and/or accessory(ies) to allow the vehicle to be quickly converted from a display configuration to a driving configuration (in which the document display housing and/or accessory(ies) are removed to enhance visibility through the door glass).

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1A is a front view of an information display device according to an example embodiment of the present invention.

FIG. 1B is a schematic side view of the information display device of FIG. 1A.

FIG. 2 is a side view of an information display device according to another example embodiment of the present invention.

FIG. 3A is a rear view of an information display device according to another example embodiment of the present invention.

FIG. 3B is a side view of the information display device of FIG. 3A.

FIG. 3C is a front view of the information display device of FIG. 3A.

FIG. 4A is a top view of a portion of the information display device of FIG. 3A.

FIG. 4B is a bottom view of a portion of the information display device of FIG. 3A.

FIG. 5A is a rear view of a document holder portion of the information display device of FIG. 3A.

FIG. 5B is a side view of a document holder portion of the information display device of FIG. 3A.

FIG. 6 is a perspective view of a clip portion of the information display device of FIG. 3A.

FIG. 6A is a sectional view of the clip portion of the information display device of FIG. 6.

FIG. 6B is a side elevation view of the clip portion of the information display device of FIG. 6.

FIG. 6C is a rear view of the clip portion of the information display device of FIG. 6.

FIG. 6D is a front view of the clip portion of the information display device of FIG. 6.

FIG. 6E is a top view of the clip portion of the information display device of FIG. 6.

FIG. 6F is a bottom view of the clip portion of the information display device of FIG. 6.

FIG. 7 is a perspective view of a top rail portion of the information display device of FIG. 3A.

FIG. 7A is a sectional view of the top rail portion of the information display device of FIG. 7.

FIG. 7B is a top view of the top rail portion of the information display device of FIG. 7.

FIG. 7C is a rear view of the top rail portion of the information display device of FIG. 7.

FIG. 7D is a bottom view of the top rail portion of the information display device of FIG. 7.

FIG. 7E is a sectional view of the top rail portion of the information display device of FIG. 7.

FIG. 7F is a side elevation view of the top rail portion of the information display device of FIG. 7.

FIG. 8A is a front view of an information display device according to another example embodiment.

FIG. 8B is a side elevation view of the information display device of FIG. 8A.

FIG. 8C is a side sectional view of the information display device of FIG. 8A.

FIG. 8D is a rear elevation view of the information display device of FIG. 8A.

FIG. 9A is a top view of a portion of the information display device of FIG. 8A.

FIG. 9B is a bottom view of a portion of the information display device of FIG. 8A.

FIG. 10A is a rear view of a document holder portion of the information display device of FIG. 8A.

FIG. 10B is a side view of a document holder portion of the information display device of FIG. 8A.

FIG. 11 is a perspective view of a top rail portion of the information display device of FIG. 8A.

FIG. 11A is a sectional view of the top rail portion of the information display device of FIG. 11.

FIG. 11B is a top view of the top rail portion of the information display device of FIG. 11.

FIG. 11C is a rear view of the top rail portion of the information display device of FIG. 11.

FIG. 11D is a bottom view of the top rail portion of the information display device of FIG. 11.

FIG. 11E is a sectional view of the top rail portion of the information display device of FIG. 11.

FIG. 11F is a side elevation view of the top rail portion of the information display device of FIG. 11.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

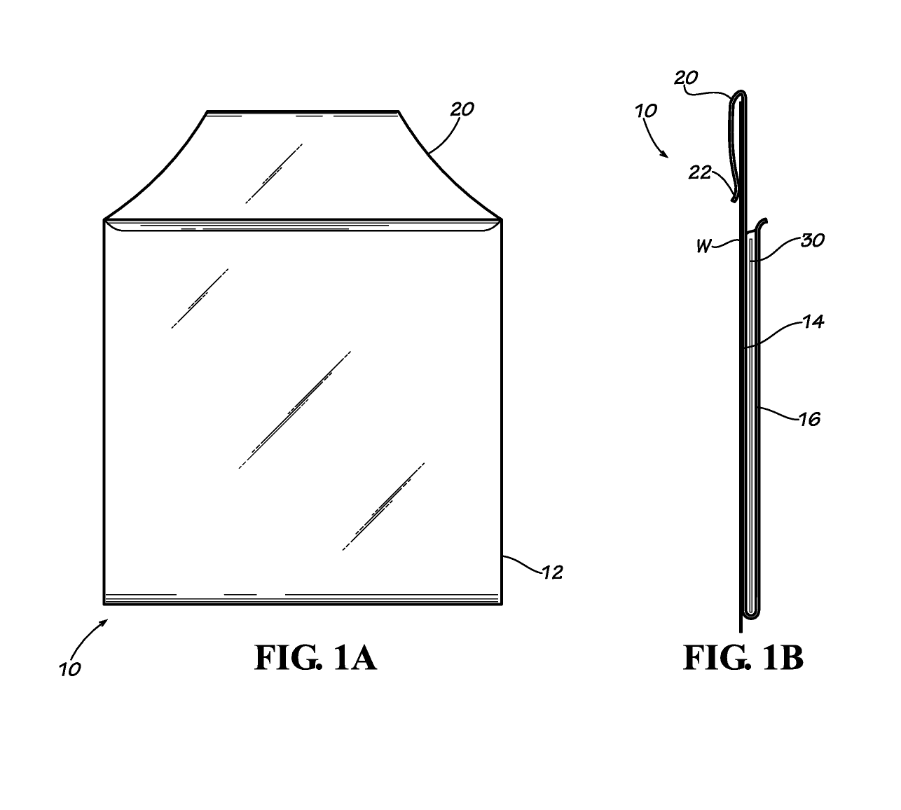

With reference now to the drawing figures, wherein like reference numbers represent corresponding parts throughout the several views, FIGS. 1A and 1B show a first embodiment of an information display device 10 according to an example form of the invention. The device 10 generally is affixed to the window of a car to position printed vehicle information adjacent the inside surface of the window. The device 10 comprises an envelope or housing 12 formed of an inner panel 14 and an outer panel 16, and a hanger or clip portion 20 attached at an upper end of the inner panel 14. The housing 12 defines a generally rectangular inner chamber having a height, a width and a depth sufficient to receive one or more sheets of printed informational material 30 about the automobile or other item to which the device is intended to be secured. The bottom of the housing and optionally the left and right sides are closed by a web connecting the edges of the inner and outer panels, and the top of the housing is open for access to the inner chamber. At least a portion, and preferably all, of the inner panel 14 is transparent or translucent to allow viewing of the contents of the housing 12 therethrough. For example, buyer's guide information about an automobile can be printed on plain paper and removably inserted into the chamber of the housing 12 for display on an automobile at a sales lot. Optionally, a closure or seal can be provided at the open upper end of the housing's inner chamber of the housing 12 to protect the contents from the elements or from inadvertent removal, but allow easy opening for removal and replacement of the contents to facilitate ease of reuse of the device. Optionally, one or more drain holes or slots can be provided at the bottom of the housing to allow drainage of any liquid that might enter the chamber.

The hanger or clip portion 20 preferably comprises a hooked portion having a concave recess for placement over the top of a window W of an automobile, whereupon the window can be closed to retain the information display device 10 in position along the inside of the window, with the informational material displayed through the window and visible from outside of the automobile. In one example form, the clip portion 20 is integral with the housing portion 12. Alternatively the clip 20 can comprise a separately formed component which is attached to the housing by adhesive, fasteners, plastic welding, connectors or other attachment means. The hooked portion of the clip 20 preferably is formed of a somewhat flexible material to permit the hook to flex as it is mounted to a window. Optionally, the clip 20 has an outwardly curved free end 22 for easing installation of the clip over a window.

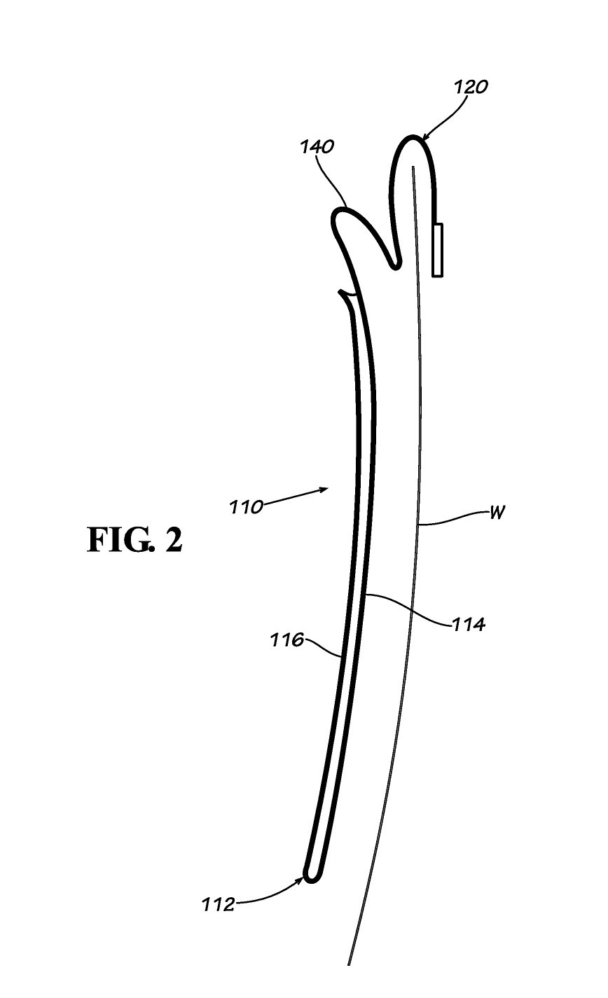

FIG. 2 shows a second example embodiment of an information display device 110 according to the present invention. This embodiment is similar to that described above, having a housing or envelope 112 comprising an inner panel 114 and an outer panel 116, and a hanger or clip portion 120 attached at an upper end of the inner panel 114. In this embodiment, a resilient spring portion 140 is provided between the clip 120 and the housing 112, so as to bias the inner panel 114 of the housing against the window W in use, for better viewing of the contents of the housing through the window from the vehicle's exterior. By holding the housing 112 fast against the inner surface of the window W, the contents of the housing 120 are more easily read. In example forms, the spring portion 140 comprises a serpentine or S-shaped compound curved strip of resilient material such as flexible plastic, metal or other materials.

The device of the present invention can be constructed of various materials, for example a clear hard plastic, polycarbonate, polyethylene, other polymers, glass, composites, or other materials. Moreover, it will be understood that the size, shape and proportions may vary depending on the particular intended application. For vehicle buyer's guide applications, example dimensions include: a housing height of about 8″-15″, for example about 11″; a housing width of about 6″-12″, for example about 8¾″; and a housing depth of about 0.05″-0.5″, for example about ¼″. In alternate embodiments, the housing chamber optionally has sufficient depth to hold multiple sheets of information so that potential customers can take one to review and keep for later consideration. In further alternate forms, the device is optionally configured to be positioned on the exterior of an automobile window, or configured for use on either the interior or the exterior, to permit potential customers to take an informational sheet if the dealership is closed and they are unable to access the vehicle's interior. A closure or seal is preferably provided with embodiments intended for exterior use, to prevent water or debris from entering the housing chamber.

In an example method of use, an automobile information sheet or buyer's guide is prepared and inserted into the inner chamber of the housing with the information or other material to be displayed facing the inner panel. The clip portion is placed over the window of a vehicle, with the housing on the interior side of the window (within the vehicle's interior passenger compartment). The window may then be closed (raised) to secure the device in place on the vehicle with the inner panel facing or against the interior face of the window. A potential customer can then view the displayed information through the window from outside of the vehicle. The device can be removed quickly and easily for test drives or when the vehicle is sold by simply opening the window and releasing the clip from the window. The informational material can be updated by removing the old material sheet and inserting a new material sheet into the inner chamber of the housing for reuse and reattachment to the same vehicle or to a different vehicle.

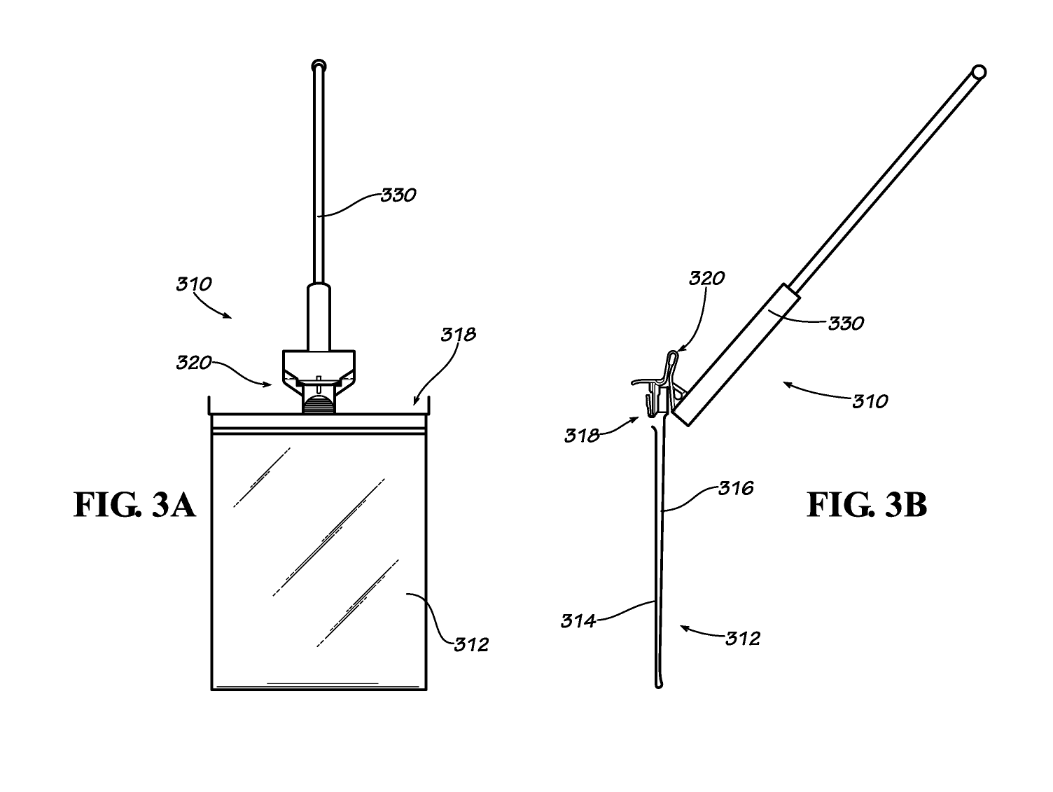

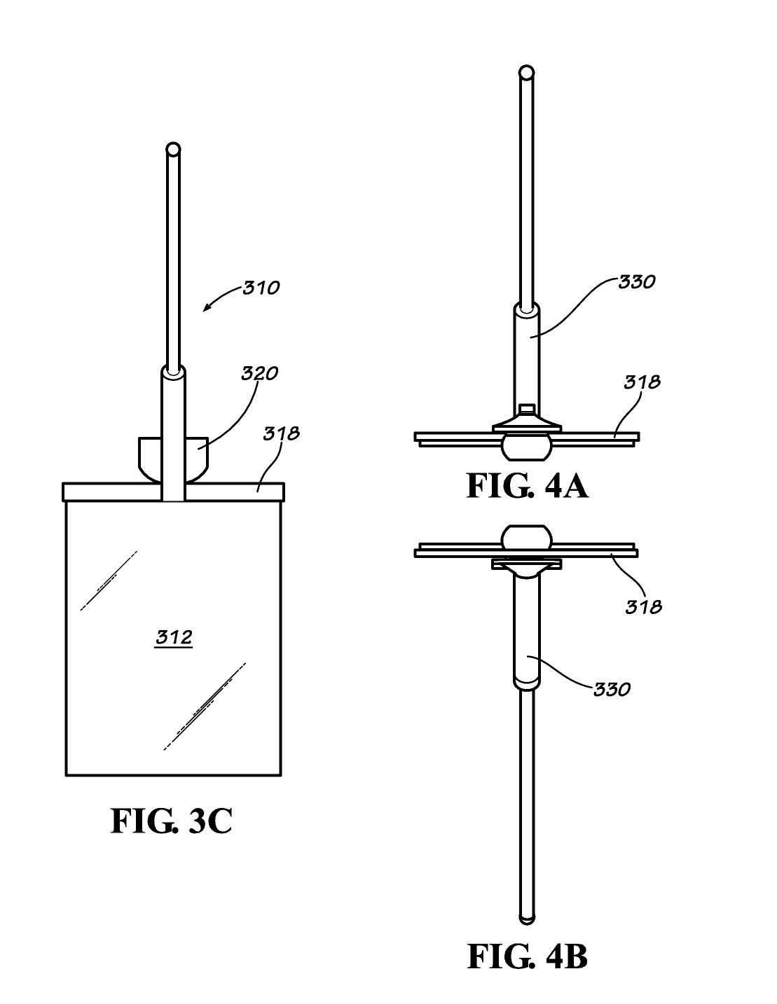

FIG. 3A is a rear view of an information display device 310 according to another example embodiment of the present invention, with FIG. 3B being a side view and FIG. 3C being a front view of the information display device 310. These figures show an embodiment according to another example form of the invention. The device 310 generally comprises a display housing or envelope 312 including an inner panel 314 and an outer panel 316, a rail 318 supporting the display housing 312, and a hanger or clip portion 320 for slipping over the door glass of a vehicle and for supporting the rail 318. The display housing 312 defines a generally rectangular inner chamber having a height, a width and a depth sufficient to receive one or more sheets of printed informational material about the automobile or other item to which the device is intended to be secured. The bottom of the display housing (and optionally the left and right sides) is closed by a web connecting the edges of the inner and outer panels, and the top of the display housing is open for access to the inner chamber. At least a portion, and preferably all, of the inner panel 314 is transparent or translucent to allow viewing of the contents of the housing 312 therethrough. For example, buyer's guide information about an automobile can be printed on plain paper and removably inserted into the chamber of the display housing 312 for display on an automobile at a sales lot. Optionally, a closure or seal can be provided at the open upper end of the display housing's inner chamber of the housing 312 to protect the contents from the elements or from inadvertent removal, but allow easy opening for removal and replacement of the contents to facilitate ease of reuse of the device. Optionally, one or more drain holes or slots can be provided at the bottom of the display housing to allow drainage of any fluid entering the chamber.

The information display device 310 also includes an optional flagpole 330 which is removably received in the clip 320. The flagpole 330 can support a flag (unshown) for drawing attention of potential buyers to this particular automobile or the business generally. Moreover, other accessories can be mounted to the clip 320 as desired. The flagpole 330 can also be seen well in FIGS. 4A and 4B.

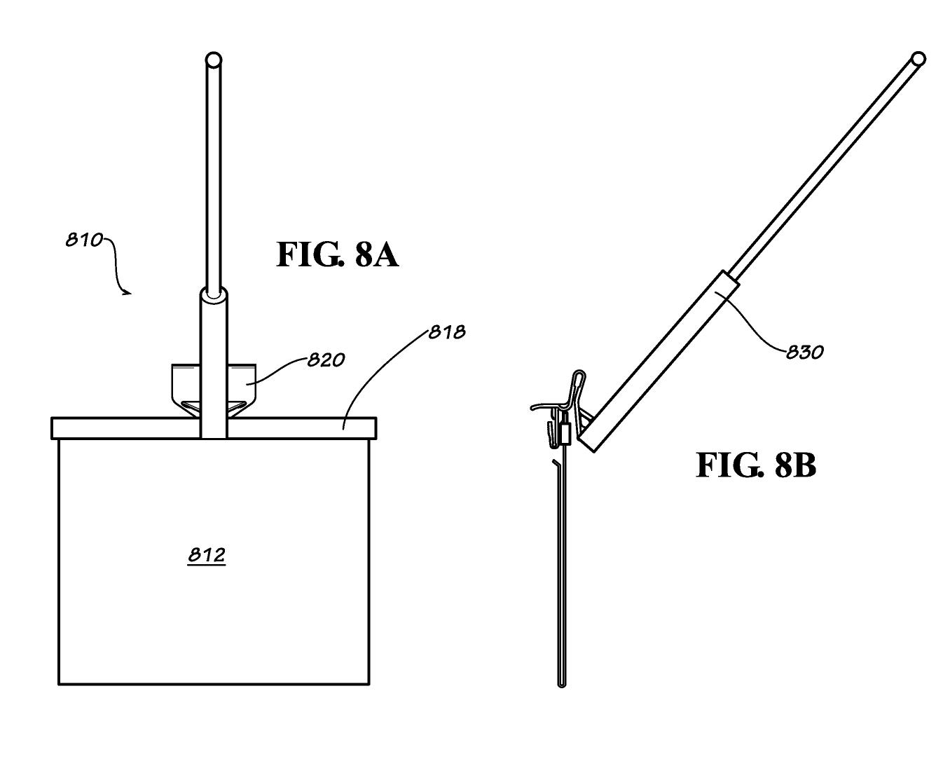

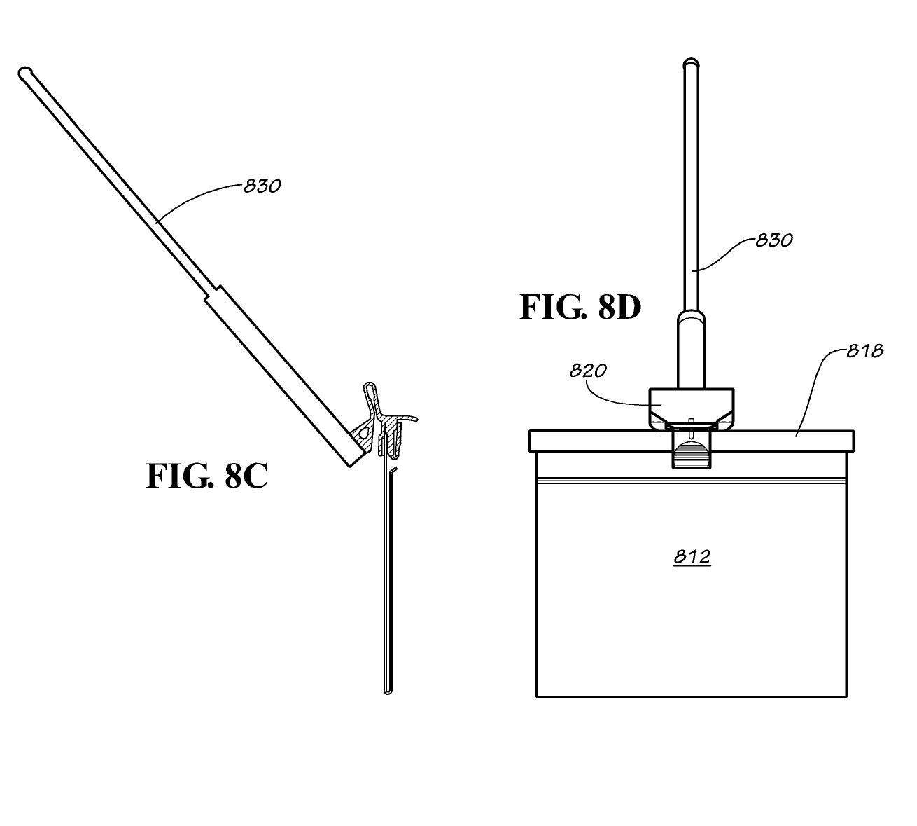

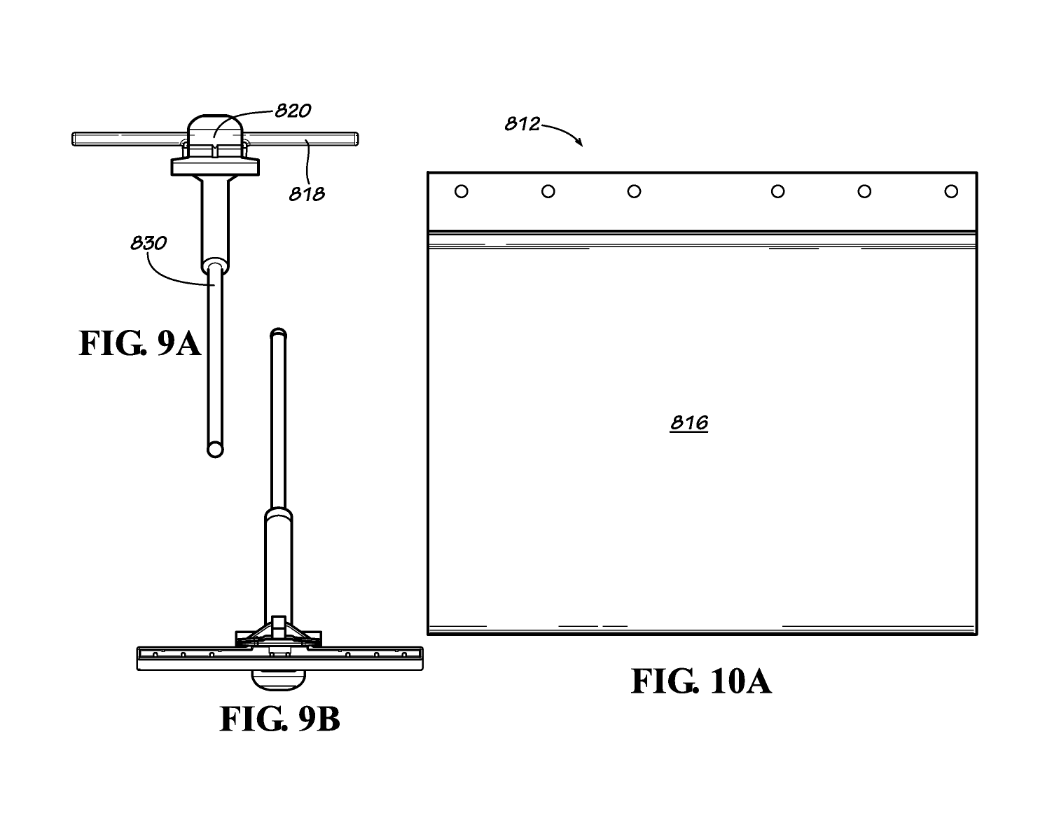

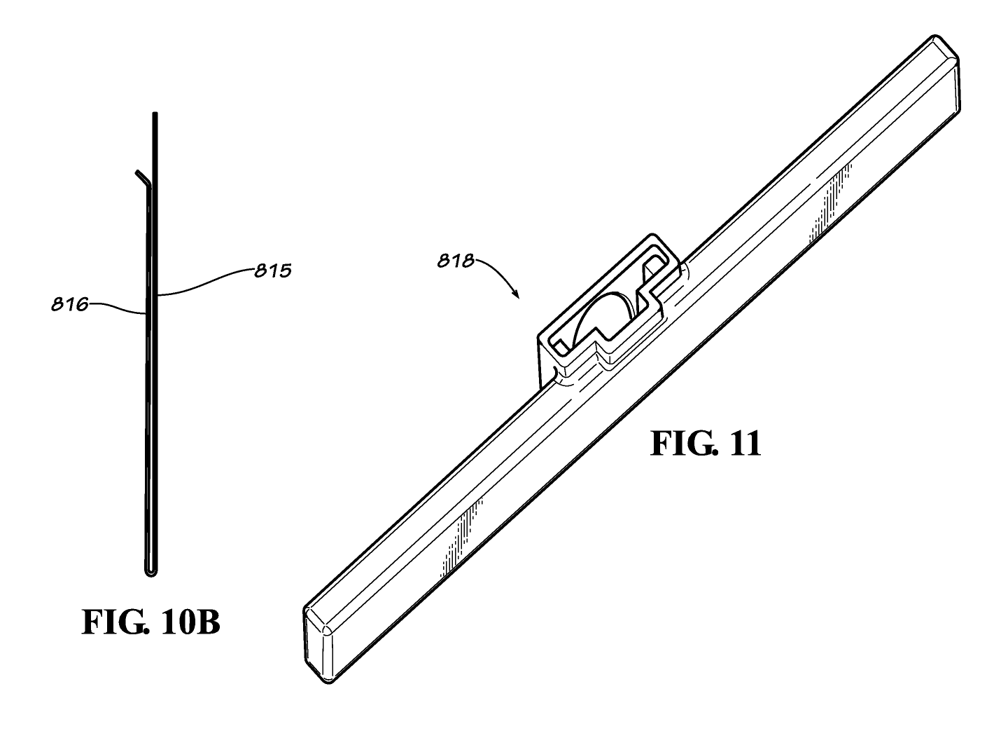

Advantageously, the display housing 312, the rail 318, the clip 320, the flagpole 330, etc., make up a modular information display device 310 which can be configured in different ways. For example, in the embodiment shown in FIGS. 3A-5B, the modular information display device 310 is configured to display documents in a more or less vertical (portrait) mode. Thus, a (standard) 8.5×11 sheet of paper can be displayed vertically in the modular information display device 310 so configured. By contrast, the modular information display device can be configured for horizontal display of information, as shown in FIGS. 8A-10B. Moreover, the modular information display device 310 can be configured with or without the flagpole, as desired. This modularity provides excellent flexibility, allowing the car lot worker to adapt to different situations easily and seamlessly.

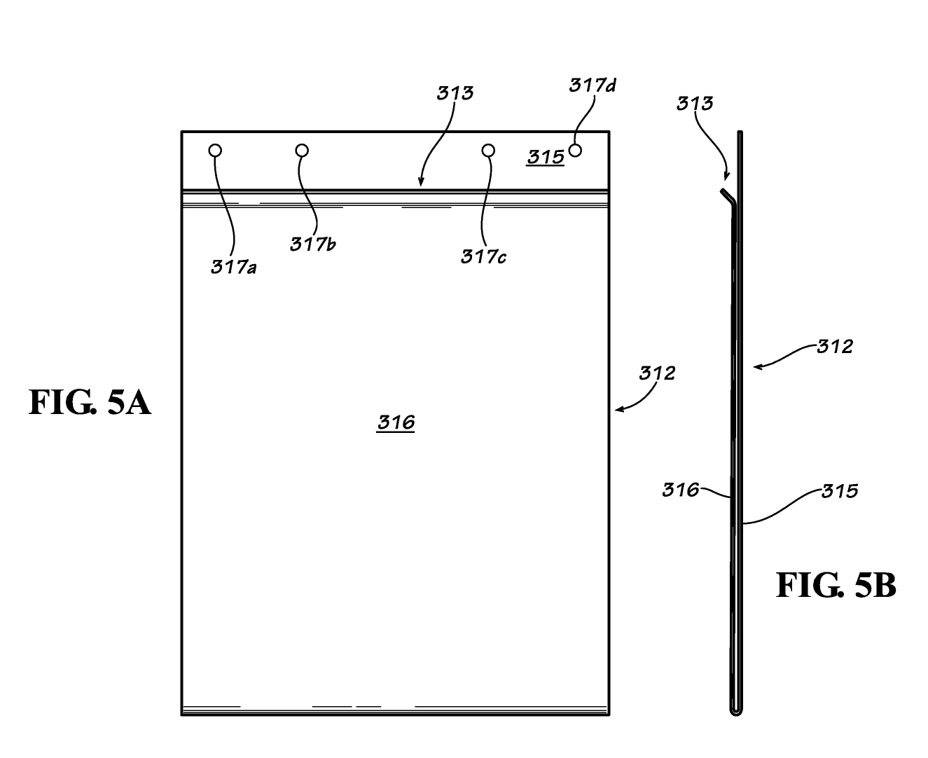

As shown in FIGS. 5A and 5B, the document display housing 312 comprises a rectangular polymer sheet which is heat bent into a long, narrow U-shape. Preferably, the sheet is 1/16 inch thick clear acrylic. Those skilled in the art will recognize that other materials can be used, as desired. An edge portion 313 is bent away from the remainder of the sheet at an approximately 45° angle to provide an easy entry for documents or other sheet-like goods into the space between the substantially parallel front and rear panels 315, 316 of the document display housing 312. Optionally, a series of four quarter-inch diameter holes 317a-317d are formed in the top portion of the front panel 315 to facilitate attachment of the document display housing 312 to the rail 318.

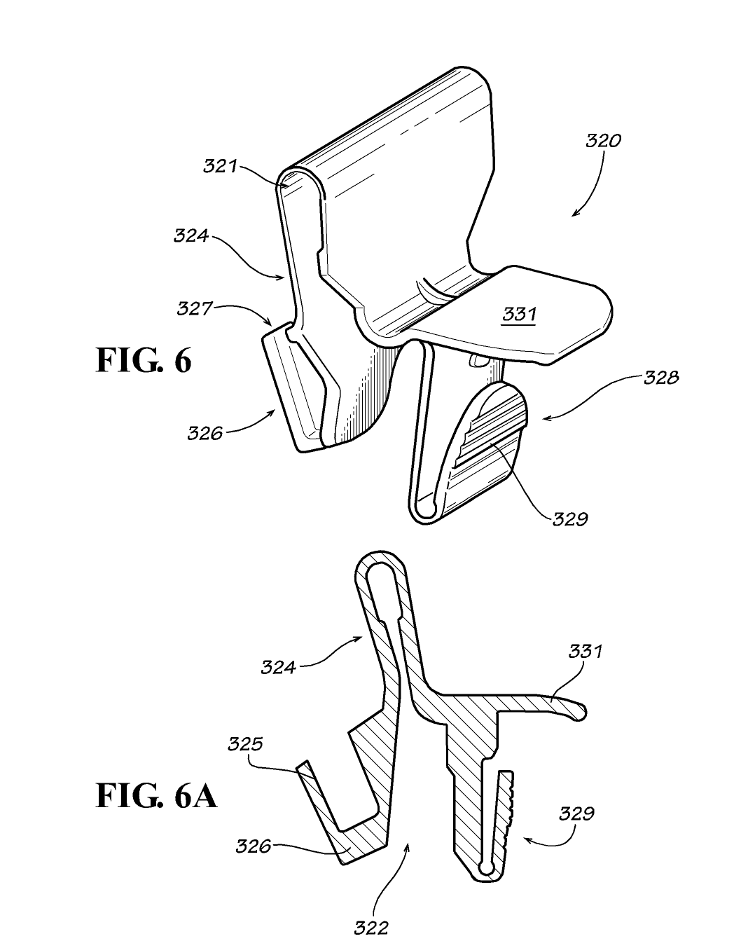

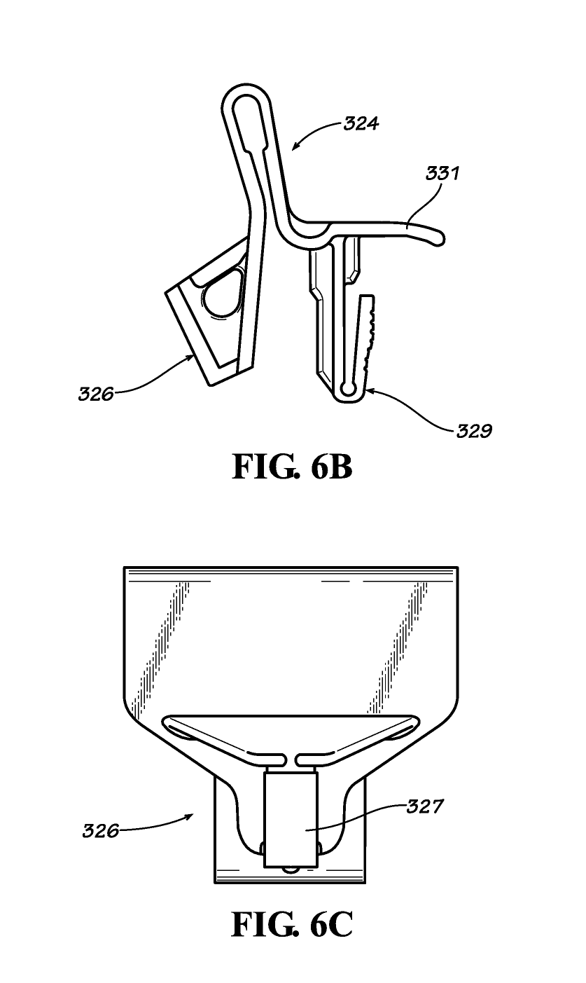

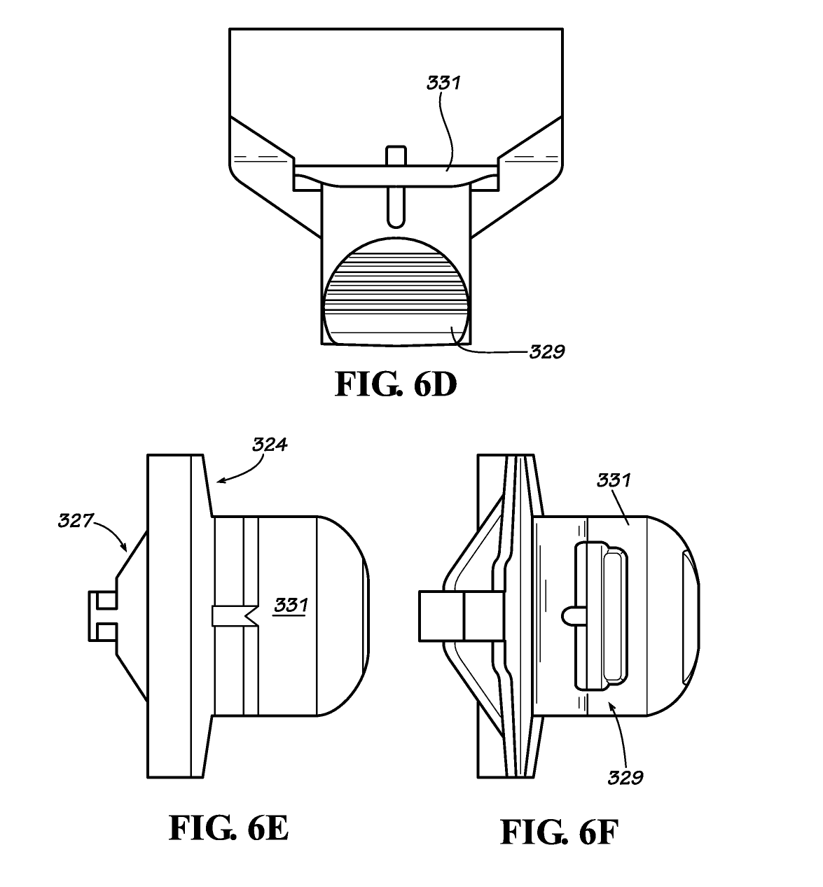

As shown in FIGS. 6-6F, the hanger or clip portion 320 preferably comprises a hooked portion 321 having a concave recess for placement over the top of a window of a vehicle, whereupon the window can be closed (raised) to retain the information display device 310 in position along the inside of the window, with the informational material displayed through the window and visible from outside of the automobile. In example forms, the clip portion 320 is separate from the document display housing 312. At least the hooked portion of the clip 320 preferably is formed of a somewhat resilient material to permit the hook to flex some as it is mounted to a window. Optionally, the clip 320 has a tapered opening 322 for easier installation of the clip over the top edge of a window.

The clip 320 is made as an injection molded plastic part and includes an upper portion 324 which forms the hooked portion 321. Preferably, the clip 320 is made from polypropylene with a UV inhibitor, although other materials can be employed. While many durable polymers can be used, the clip can also be made of metal. The clip 320 also includes a lower outer portion 326 which includes a flagpole anchor boss 327 with a bore or well 325 for supporting a flagpole therein (see FIG. 6A). Clip 320 also includes a lower inner portion indicated generally at 328 including a J-shaped hook 329 for attachment of the rail 318 and for supporting the rail. A lift tab 331 is provided for facilitating installation and removal of the clip 320 on a vehicle window.

The clip can be used for securing other items to the window, such as an electronic display that is programmed or configured to display the vehicle information (as opposed to or in conjunction with printed paper materials). The electronic display can be adapted to be activated by interaction with a customer or by sensing the proximity of a customer.

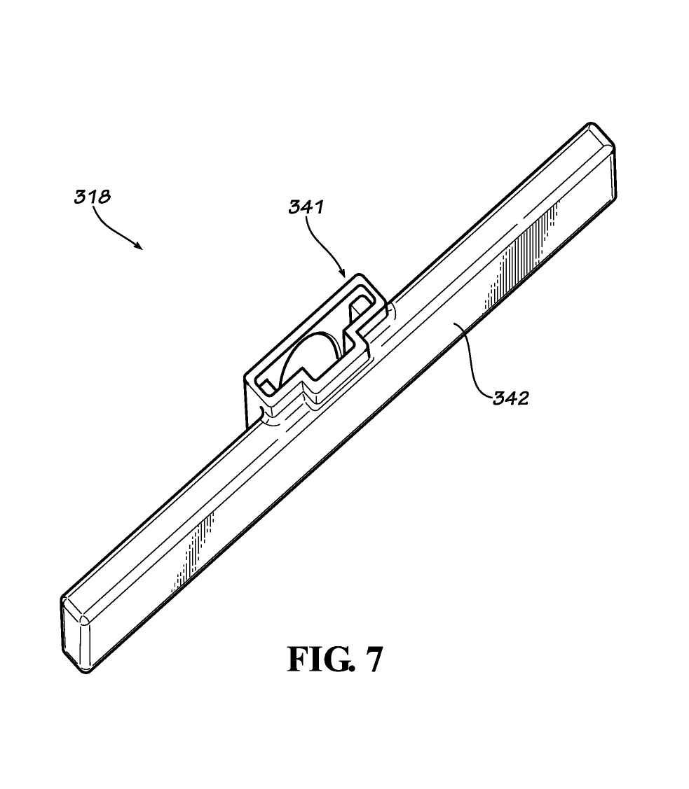

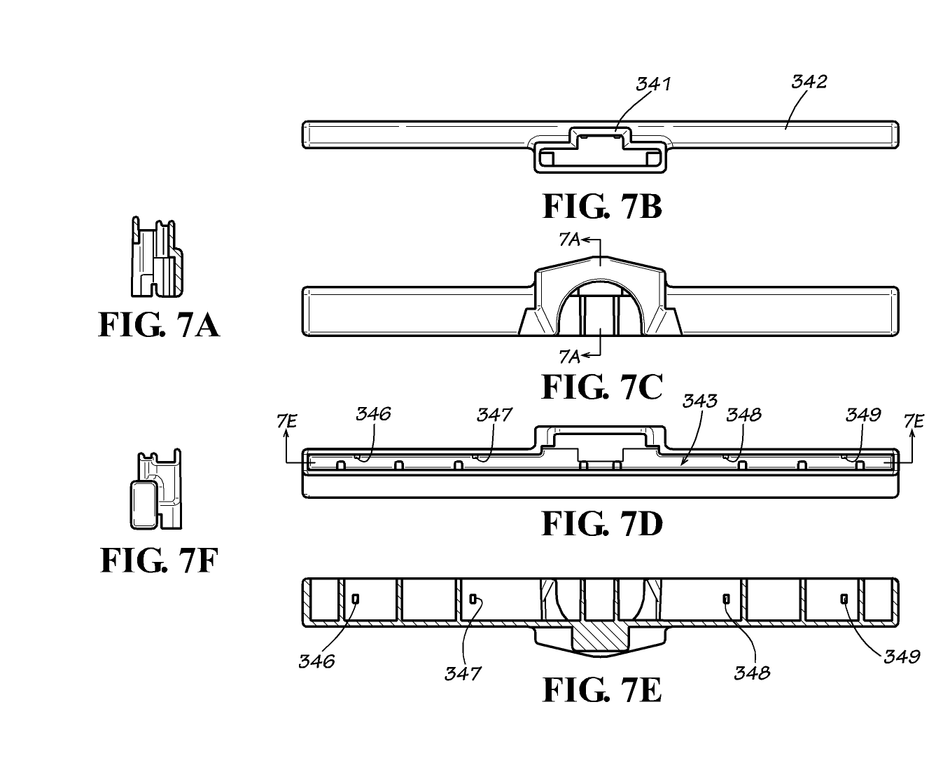

As shown in FIGS. 7-7F, the rail 318 includes a long element or elongate body 342 with a central mounting boss 341 positioned halfway along the elongate body 342. The mounting boss 341 is adapted to interact with and lock to lower portion 328 of the clip 320. Likewise, the elongate body portion 342 of the rail 318 has a hollow recess 343 (see FIG. 7D) for receiving a top portion of the document display housing 312 therein. In this regard, a series of nubs, such as nubs 346-349, interact with and engage in the quarter-inch holes 317a-317d formed in the top portion of the document display housing 312 to removably secure the document display housing to the rail 318.

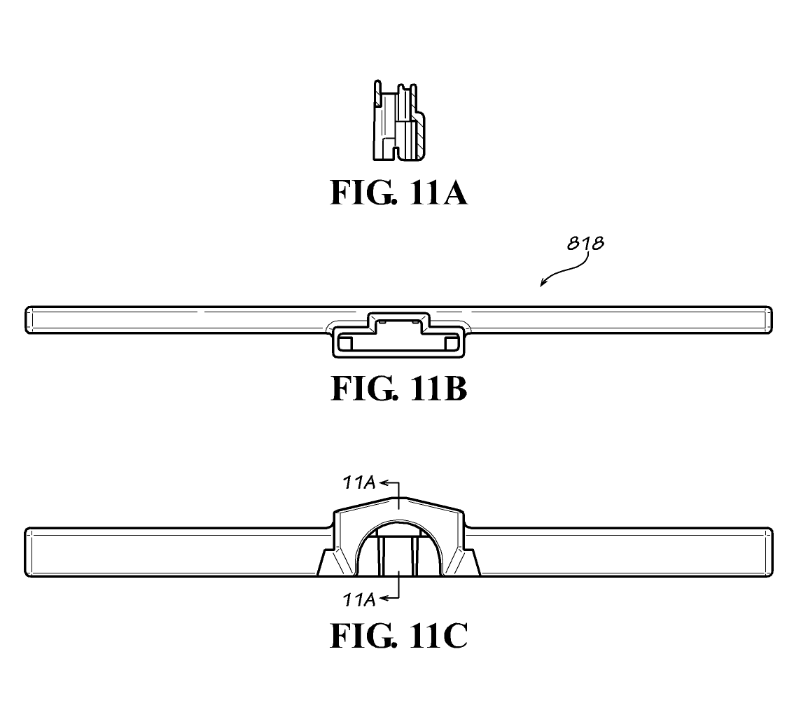

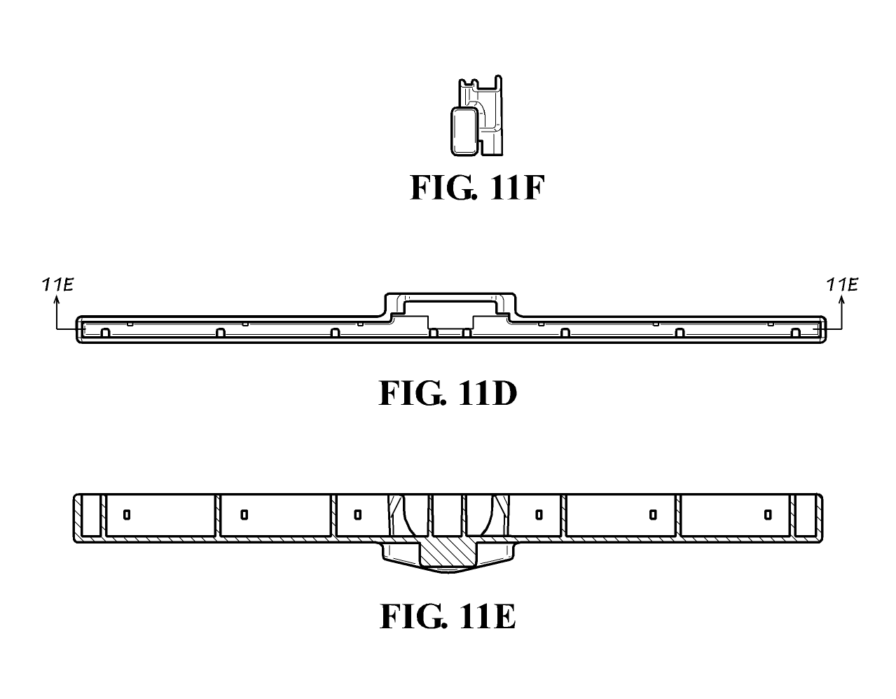

FIGS. 8A-11F show an optional and alternative arrangement 810 in which instead of the document being displayed more or less vertically, the document(s) can be displayed more or less horizontally. In this arrangement, the clip 820 is substantially identical to that of clip 320 in the previous embodiment. Moreover, the flagpole 830 is largely unchanged, although in this embodiment it is depicted as integral to the clip 320. However, the rail 818 and the document display housing 812 (including the front and back panels 815, 816) are constructed differently from that of the previous embodiment. In this embodiment, the 818 rail is wider than rail 318. Likewise, the document display housing 812 is wider than the document display housing 312 (and is not as tall). This wider version can utilize more nub/hole attachments (6 such are shown, as compared to 4 such shown in the previous embodiment). This shorter, wider figuration is particularly well-suited for those applications where the vehicle has a short side window.

While the invention has been described with reference to preferred and example embodiments, it will be understood by those skilled in the art that a variety of modifications, additions and deletions are within the scope of the invention, as defined by the following claims.

What is claimed is:

1. A modular information display device for displaying informational material regarding a vehicle for sale to a potential customer, the modular information display device comprising:
a clip adapted to be slipped over the top of a door glass of the vehicle;
a rail removably attached to the clip; and
a document display housing secured to the rail and comprising an inner panel and an outer panel, and defining a chamber therebetween for receiving and displaying a document, at least a portion of the document display housing being transparent to allow viewing of the document therethrough.

2. The modular information display device of claim 1, further comprising a resilient spring portion between the clip portion and the document display housing.

3. The modular information display device of claim 1, further comprising a flagpole and wherein the clip includes a retainer for supporting the flagpole.

4. The modular information display device of claim 1, wherein the rail and document display housing are adapted for displaying a standard 8.5×11 sheet of paper.

5. The modular information display device of claim 4, wherein the rail and document display housing are adapted for displaying a standard 8.5×11 sheet of paper in landscape mode.

6. The modular information display device of claim 4, wherein the rail and document display housing are adapted for displaying a standard 8.5×11 sheet of paper in portrait mode.

7. The modular information display device of claim 1, wherein the clip is adapted to be easily manipulated to allow rapid and easy attachment/removal of the document display housing to allow the vehicle to be quickly converted from a display configuration to a driving configuration in which the document display housing is removed to enhance visibility through the door glass.

8. A modular information display device for displaying informational material regarding a vehicle for sale to a potential customer, the modular information display device comprising:
a clip adapted to be slipped over the top of a door glass of the vehicle; and
a document display housing removably attached to the clip and comprising an inner panel and an outer panel, and defining a chamber therebetween for receiving and displaying a document, at least a portion of the document display housing being transparent to allow viewing of the document therethrough.

9. The modular information display device of claim 8, further comprising a resilient spring portion between the clip and the document display housing.

10. The modular information display device of claim 8, further comprising a flagpole and wherein the clip includes a retainer for supporting the flagpole.

11. The modular information display device of claim 8, wherein the document display housing is adapted for displaying a standard 8.5×11 sheet of paper.

12. The modular information display device of claim 11, wherein the document display housing is adapted for displaying a standard 8.5×11 sheet of paper in landscape mode.

13. The modular information display device of claim 11, wherein the document display housing is adapted for displaying a standard 8.5×11 sheet of paper in portrait mode.

14. The modular information display device of claim 8, wherein the clip is adapted to be easily manipulated to allow rapid and easy attachment/removal of the document display housing to allow the vehicle to be quickly converted from a display configuration to a driving configuration in which the document display housing is removed to enhance visibility through the door glass.

15. An information display device for displaying informational material regarding an item for sale to a potential customer, the information display device comprising:
a housing portion comprising an inner panel and an outer panel, and defining a chamber therebetween for receiving the informational material, at least a portion of the housing being transparent to allow viewing of the informational material therethrough; and
a clip portion attached at an upper end of the housing portion for attachment to the item for sale.

16. The information display device of claim 15, further comprising a resilient spring portion between the clip portion and the housing portion.

17. The information display device of claim 15, wherein the housing portion is adapted for displaying a standard 8.5×11 sheet of paper.

18. A method of displaying information about an item, the method comprising:
providing an information display device having a housing portion and a clip portion;
placing informational material about the item in the housing portion of the information display device; and
removably securing the information display device to the item by means of the clip portion.
